(19) United States
(12) Patent Application Publication
(10) Pub. No.: US 2018/0284935 A1
(43) Pub. Date: Oct. 4, 2018

(54) DISPLAY AND ELECTRONIC DEVICE INCLUDING THE SAME

(71) Applicant: Samsung Electronics Co., Ltd., Suwon-si (KR)

(72) Inventors: Young Man LEE, Seoul (KR); Su Yeon KIM, Suwon-si (KR); Seung Jae LEE, Suwon-si (KR); Woon Bo YEO, Hwaseong-si (KR); Nam Hyeon JEON, Seoul (KR)

(21) Appl. No.: 15/939,024

(22) Filed: Mar. 28, 2018

(30) Foreign Application Priority Data
Mar. 28, 2017 (KR) 10-2017-0039411

(51) Int. Cl. G06F 3/041; G06F 3/0484; G06F 3/01

(52) U.S. Cl. CPC G06F 3/0412; G06F 3/04842; G06F 3/0416; G06F 3/016; G06F 3/017

(57) ABSTRACT

A display and an electronic device are disclosed. The display includes a display panel including one or more pixels. The display also includes a display driver integrated circuit (IC) for driving the one or more pixels. The display further includes a flexible substrate extending outside the display panel from at least some layers of the display panel. The flexible substrate includes a driver IC area on which the display driver IC is disposed. The flexible substrate also includes a bending area bent in a specified direction with respect to the display panel, with an insulation member formed on the bending area and connected to the display driver IC and the display panel and an insulation member formed on the one or more interconnection wires. The bending area is narrower than the display panel connected with the bending area. The insulation member has a same width as the bending area.

CROSS-REFERENCE TO RELATED APPLICATION(S)

This application is based on and claims priority under 35 U.S.C. § 119 to Korean Patent Application No. 10-2017-0039411, filed on Mar. 28, 2017, in the Korean Intellectual Property Office, the disclosure of which is incorporated by reference herein its entirety.

### TECHNICAL FIELD

Embodiments of the present disclosure disclosed herein relate to a display and an electronic device including the same.

### BACKGROUND

An electronic device, such as a smartphone, a tablet PC, or the like, may include a display. The electronic device may output various contents, such as text, images, or the like, through the display. The display may be implemented with a window panel exposed to the outside and a display module in which a touch panel, a display panel, and the like are stacked one above another.

The display module may be implemented inside the electronic device in various ways. For example, the display module may include a flexible display, and the flexible display may include a bending area having a curved shape.

The above information is presented as background information only to assist with an understanding of the present disclosure. No determination has been made, and no assertion is made, as to whether any of the above might be applicable as prior art with regard to the present disclosure.

### SUMMARY

Interconnection wires may be arranged in the bending area of the flexible display to supply electrical signals to an active area of the display panel. A protective layer, for example, a bending protection layer (BPL) may be stacked on the flexible display to protect the interconnection wires. However, in the related art, the BPL is formed on only a part of the bending area, and therefore sides of the bending area may be vulnerable to external shocks and cracks.

Aspects of the present disclosure are to address at least the above-mentioned problems and/or disadvantages and to provide at least the advantages described below. Accordingly, an aspect of the present disclosure is to provide a display structure including a BPL.

In accordance with an aspect of the present disclosure, a display includes a display panel including one or more pixels, a display driver integrated circuit (IC) for driving the one or more pixels, and a flexible substrate extending outside the display panel from at least some layers of the display panel.

The flexible substrate includes a driver IC area on which the display driver IC is disposed and a bending area bent in a specified direction with respect to the display panel, with one or more interconnection wires formed in the bending area and connected to the display driver IC and the display panel and an insulation member formed on the one or more interconnection wires. The bending area is narrower than the display panel connected with the bending area, and the insulation member has the same width as the bending area.

In accordance with another aspect of the present disclosure, an electronic device includes a housing including a first surface facing a first direction and a second surface facing a second direction that is different from the first direction, a transparent member that forms at least a portion of the first surface of the housing, a display panel at least partly exposed through the transparent member and including one or more pixels, and a flexible substrate extending outside the display panel from at least some layers of the display panel.

The flexible substrate includes an active area corresponding to the one or more pixels and a bending area bent in a specified direction with respect to the display panel, with one or more interconnection wires formed in the bending area and connected to the display panel and an insulation member formed on the one or more interconnection wires. The bending area is narrower than the display panel connected with the bending area, and the insulation member has the same width as the bending area.

According to embodiments of the present disclosure, a side of a display that is vulnerable to external shocks may be effectively protected.

In addition, the present disclosure may provide various effects that are directly or indirectly recognized.

Other aspects, advantages, and salient features of the disclosure will become apparent to those skilled in the art from the following detailed description, which, taken in conjunction with the annexed drawings, discloses various embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an exploded perspective view of an electronic device according to an embodiment;

FIG. 2 illustrates an internal configuration of an electronic device according to an embodiment;

FIG. 3 illustrates a schematic view of a configuration of a display according to an embodiment;

FIG. 4 illustrates a flowchart of a process of manufacturing a display according to an embodiment;

FIG. 5 illustrates a cutting pattern of a bending area according to an embodiment;

FIG. 6 illustrates a cutting pattern of a bending area according to another embodiment;

FIG. 7 illustrates a cutting pattern of a bending area according to another embodiment;

FIG. 8 illustrates a cross-section of a display according to an embodiment;

FIG. 9 illustrates a removal pattern in a bending area according to an embodiment;

FIG. 10 illustrates a cross-section of a display according to an embodiment; and

FIG. 11 illustrates a block diagram of an electronic device in a network environment according to various embodiments.

Throughout the drawings, it should be noted that like reference numbers are used to depict the same or similar elements, features, and structures.

### DETAILED DESCRIPTION

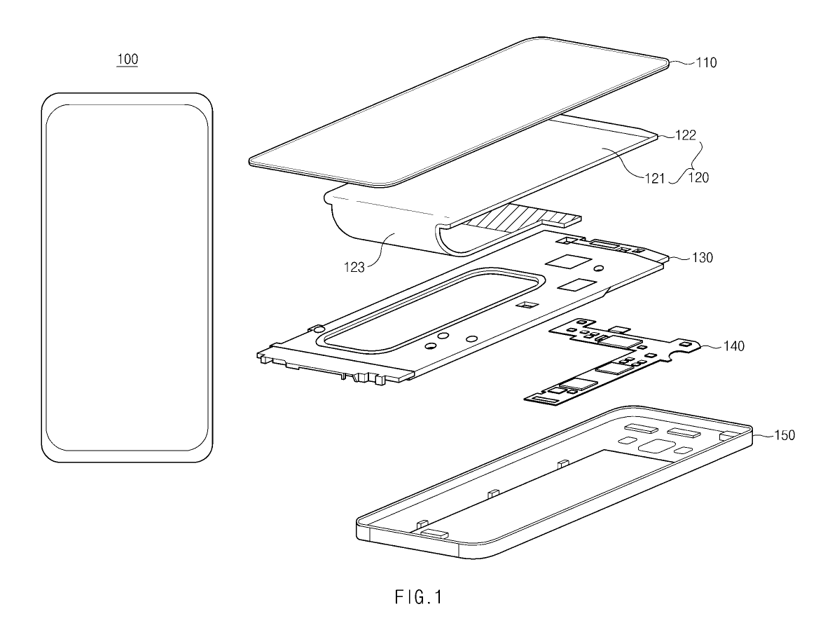

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, various embodiments of the present disclosure may be described with reference to accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar elements may be marked by similar reference numerals.

FIG. 1 illustrates an exploded perspective view of an electronic device according to an embodiment.

According to an embodiment, an electronic device 100 may include a housing. The housing may include a first surface facing a first direction and a second surface facing a second direction that is opposite to the first direction. According to an embodiment, the first surface may include a transparent member. The transparent member may be, for example, a window panel 110. According to an embodiment, the second surface may be a case 150. According to an embodiment, the first surface may include a first side and a second side that extend in a third direction and a third side and a fourth side that extend in a fourth direction different from the first direction. The first side and the second side may be shorter than the third side and the fourth side. According to an embodiment, the third direction may be perpendicular to the fourth direction.

Referring to FIG. 1, the electronic device 100 according to an embodiment may include, inside the housing thereof, the window panel (or window cover) 110, a display 120, a support member 130, and an internal circuit 140. The configuration of the electronic device 100 illustrated in FIG. 1 is illustrative, and various modifications according to various embodiments of the present disclosure may be made. For example, the electronic device 100 may further include a touch panel for obtaining a user's touch input, a pressure sensor, a fingerprint sensor, a digitizer for obtaining an input of an electronic pen, or the like.

The electronic device 100 may include the window panel 110 exposed to the outside. The window panel 110 according to an embodiment may be formed of a transparent material to allow the display 120 to be exposed to the outside. The window panel 110 may be referred to as the transparent member. The transparent member according to an embodiment may be a glass or plastic cover.

The electronic device 100 according to an embodiment may output various contents (e.g., text, images, or the like) through the display 120. According to an embodiment, the display 120 may be bonded and secured to the support member 130, which is located inward of the display 120, through various adhesive members. The display 120 according to an embodiment may be a flexible display.

According to an embodiment, the display 120 may include an active area 121 on which an image is output and a non-active area 122. According to an embodiment, the non-active area 122 may be disposed around the active area 121. The active area 121 may be an area on which text or an image is output under the control of a processor, a display driver integrated circuit (IC), and the like that are located inward of the active area 121. According to an embodiment, the active area 121 may include pixels. The active area 121 may be disposed in the center of the display 120 and may face a specified direction. For example, the active area 121 may face the first direction and/or a direction different from the first direction. The non-active area 122 may include interconnection wires, circuits, and the like for driving the active area 121. The non-active area 122 may be a peripheral area that surrounds the active area 121.

According to an embodiment, the display 120 may include a bending area 123 that is bent in the second direction. The bending area 123 may be disposed in the non-active area 122. According to an embodiment, the interconnection wires, the circuits, and the like for driving the active area 121 may be arranged in the bending area 123.

According to an embodiment, a portion of the non-active area 122 may be narrower than the display 120 corresponding to the active area 121. The bending area 123 may be narrower than the display 120 corresponding to the active area 121.

The display 120 according to an embodiment may be implemented with a chip on plastic (COP). According to an embodiment, the display 120 may include a flexible substrate, and interconnection wires may be arranged in a non-active area (e.g., the non-active area 122) of the flexible substrate to connect the display driver IC and the pixels.

The support member 130 may support and fix the display 120 and the internal circuit 140. The internal circuit 140 may include various elements for driving, such as a sensor, a vibration device, a battery, a printed circuit board (PCB), and the like. The case (or outer housing) 150 may include the second surface of the electronic device 100, or may surround and protect the second surface of the electronic device 100.

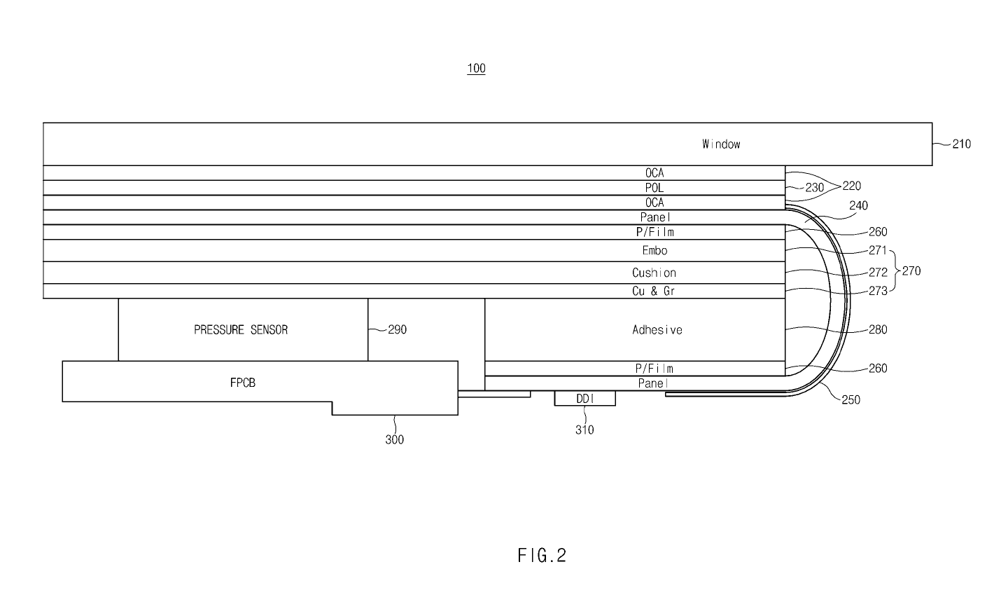

FIG. 2 illustrates an internal configuration of an electronic device according to an embodiment.

Referring to FIG. 2, an electronic device (e.g., the electronic device 100 of FIG. 1) may include a window panel 210 (e.g., the window panel 110 of FIG. 1), an optical clear adhesive (OCA) layer 220, a polarizer (POL) 230, a display panel 240, a BPL 250, a P/film 260, a back panel 270, an adhesive layer 280, a pressure sensor 290, a flexible printed circuit board (FPCB) 300, and/or a display driver integrated circuit (DDI) 310.

According to an embodiment, the window panel (or window cover) 210 may pass light generated by the display panel 240. According to an embodiment, the OCA layer 220, which is a transparent adhesive layer, may bond the window panel 210 and the polarizer 230 together.

The polarizer (or polarizer film) 230 may pass only part of light incident through the window panel 210, which the part oscillates in a specific direction. For example, the polarizer 230 may pass only light oscillating in the vertical direction and may block light oscillating in the horizontal direction.

According to an embodiment, the display panel 240 may include one or more pixels to which signals are supplied. The display panel 240 may include scan lines, data lines, and light-emitting diodes (e.g., OLEDs) that emit light based on signals supplied through the scan lines and the data lines.

According to an embodiment, the display panel 240 may include a flexible substrate. According to an embodiment, the flexible substrate may extend from at least some layers of the display panel 240 to the outside. The flexible substrate may be a substrate made of plastic or polymer. The display panel 240 may include a substrate that contains at least one of, for example, polyethylene terephthalate (PET), polyethylene naphthalate (PEN), polyethylene sulfide (PES), polyethylene (PE), and polyimide (PI). According to an embodiment, interconnection wire(s) for supplying power and/or signals may be arranged on the flexible substrate.

According to an embodiment, the display panel 240 may include a substrate on which the light-emitting diodes are mounted and a thin film encapsulation (TFE) for protecting the light-emitting diodes.

According to an embodiment, the P/film 260 may be disposed below the display panel 240 to support the display panel 240. The P/film 260 may be, for example, a PF film. According to an embodiment, interconnection wire(s) for supplying power and/or signals to the display panel 240 may be mounted on the P/film 260.

According to an embodiment, the BPL 250 may be stacked on a bending area (e.g., the bending area 123 of FIG. 1) of the display panel 240. The BPL 250 may be attached to the display panel 240 to prevent the substrate from being broken. Also, the BPL 250 may be disposed to cover the interconnection wires, thereby protecting the interconnection wires vulnerable to cracking.

According to an embodiment, the back panel 270 may be disposed below the P/film 260. The back panel 270 may include at least one of a light-shielding layer 271 (e.g., an EMBO layer), a buffer layer 272 (e.g., a sponge layer), and a metal plate layer 273 (e.g., a copper (CU) & graphite layer). According to an embodiment, the pressure sensor 290 may obtain the magnitude of pressure exerted by a user input (e.g., an input by a finger or an electronic pen) on the window panel 210.

According to an embodiment, an opening (e.g., an opening with a thickness of 0.1 mm to 0.18 mm) may be formed in at least a partial area of the back panel 270. A fingerprint sensor (not illustrated) may be disposed in an area corresponding to the opening. According to an embodiment, the fingerprint sensor may obtain fingerprint information through the opening. In the case where the fingerprint sensor is of an optical type, the fingerprint sensor may be disposed in an area corresponding to the opening. In the case where the fingerprint sensor is of a capacitive type, an opening may not be formed in the back panel 270, or the fingerprint sensor may be disposed irrespective of the opening.

According to an embodiment, the pressure sensor 290 may be disposed to correspond to the entire surface of the display panel 240, or may be disposed to correspond to only a partial area of the display panel 240. The pressure sensor 290 may be disposed to surround the fingerprint sensor.

According to an embodiment, the FPCB 300 may be electrically connected to a partial area of the display panel 240 and/or the P/film 260. For example, the FPCB 300 may be electrically connected to the interconnection wires formed on the substrate of the display panel 240.

According to an embodiment, the DDI 310 may drive the pixels of the display panel 240. According to an embodiment, the DDI 310 may be disposed on a display. The DDI 310 may be disposed on a partial area of the display. The DDI 310 may be electrically connected to, for example, the interconnection wires and the pixels arranged in the display.

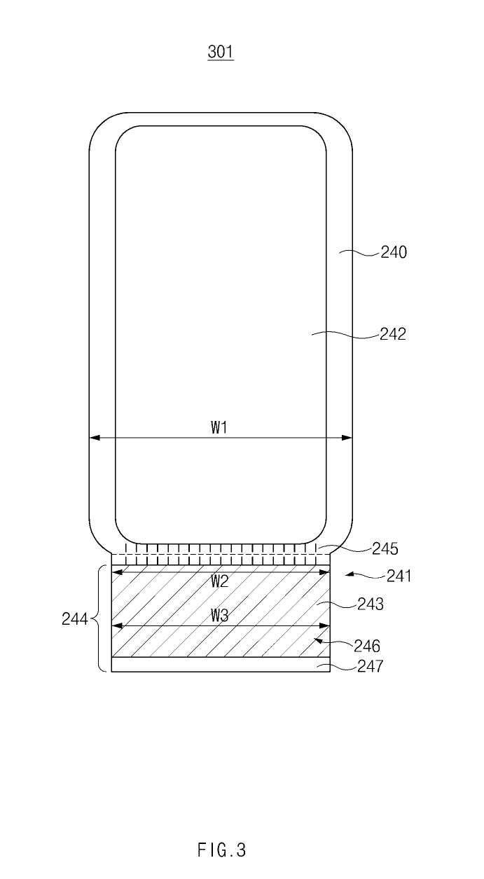

FIG. 3 illustrates a schematic view of a configuration of a display according to an embodiment.

According to an embodiment, a display 301 may include a display panel (e.g., the display panel 240 of FIG. 2) and/or a display driver integrated circuit (DDI) (e.g., the DDI 310 of FIG. 2). In embodiments of the present disclosure, the configuration of the display 301 may be diversely modified. For example, the display 301 may further include a BPL 246 (e.g., the BPL 250 of FIG. 2) and/or interconnection wires 245.

The display panel 240 according to an embodiment may include a substrate 241 extending from some layers of the display panel 240 to the outside. The substrate 241 may be, for example, a flexible substrate.

The display panel 240 may include an active area 242 (e.g., the active area 121 of FIG. 1) and a non-active area 243 (e.g., the non-active area 122 of FIG. 1) that surrounds the active area 242 or is connected to the active area 242. According to an embodiment, the non-active area 243 may include a bending area 244 in which one or more interconnection wires 245 (hereinafter, referred to as the interconnection wires 245) are arranged. According to an embodiment, the bending area 244 may include the insulation member (or protective member) 246 formed on the interconnection wires 245.

According to an embodiment, the bending area 244 may be bent when the flexible substrate (or flexible film) 241 (e.g., a PI film) is curved. For example, the bending area 244 may be bent in a specified direction with respect to the display panel 240, with the interconnection wires 245 formed in the bending area 244 and the insulation member 246 formed on the interconnection wires 245. The bending area 244 according to an embodiment may be formed of a flexible material. For example, the bending area 244 may be implemented with an ultra violet (UV) curable resin or a naturally curable resin.

The interconnection wires 245 may be electrically connected to the display driver integrated circuit (e.g., the DDI 310 of FIG. 2). The interconnection wires 245 according to an embodiment may be arranged in the bending area 244 in various patterns. For example, the interconnection wires 245 may be arranged in a form in which a single straight, curved, or corrugated interconnection wire branches in the bending area 244.

According to an embodiment, the flexible substrate 241 may include a driver IC area 247 on which the DDI is disposed. According to an embodiment, the bending area 244 of the flexible substrate 241 may include the driver IC area 247. The driver IC area 247 may be located on the opposite side to an area of the display panel 240 from which the flexible substrate 241 extends. The DDI according to an embodiment may be implemented in the form of a chip on plastic (COP) on the driver IC area 247.

According to an embodiment, for ease of bending, the bending area 244 may be narrower than the display panel 240 connected with the bending area 244. When the width of the bending area 244 is denoted by w2 and the width corresponding to the active area 242 of the display 301 or the display panel 240 is denoted by w1, w2 may be less than w1.

According to an embodiment, the display 301 may include the insulation member 246 to protect the interconnection wires 245 from external shocks or to prevent the interconnection wires 245 from being corroded by moisture. The insulation member 246 may be, for example, a BPL (the BPL 250 of FIG. 2). According to an embodiment, the insulation member 246 may be stacked on the display panel 240. The insulation member 246 may be stacked on, for example, a partial area of the display panel 240.

The interconnection wires 245 or the substrate 241 may crack when the bending area 244 is bent. To minimize the occurrence of cracks, the insulation member 246 may have substantially the same width as that of the bending area 244, or may be disposed to cover the width of the bending area 244. For example, the width w3 of the insulation member 246 in the third direction may be greater than or equal to the width w2 of the bending area 244 in the third direction.

According to an embodiment, the insulation member 246 may be formed separately from an insulation member (or protective member) disposed in the active area 242. According to an embodiment, the insulation member 246 on the bending area 244 and the insulation member in the active area 242 may be implemented with different materials.

In the following embodiments, the insulation member (or protective member) 246 may be referred to as the insulation layer, protective layer, or BPL 246.

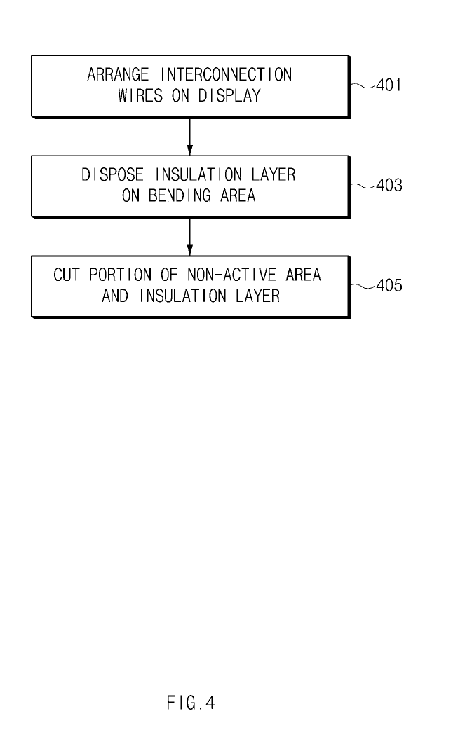

FIG. 4 illustrates a flowchart of a process of manufacturing a display according to an embodiment.

Referring to FIG. 4, after a BPL (e.g., the BPL 250 of FIG. 2) is applied to a display (e.g., the display 301 of FIG. 3), a portion of a non-active area (e.g., the non-active area 243 of FIG. 3) may be cut together with the BPL 250.

First step 401 may be a step of arranging interconnection wires (e.g., the interconnection wires 245 of FIG. 3) on the display. For example, first step 401 may be a step of arranging the interconnection wires on a display panel (e.g., the display panel 240 of FIG. 2) or a flexible substrate. According to an embodiment, the interconnection wires may be arranged in a bending area (e.g., the bending area 244 of FIG. 3) of the display.

According to an embodiment, first step 401 may include a step of arranging pixels. The pixels may be arranged in an active area (e.g., the active area 242 of FIG. 3). The interconnection wires may be electrically connected to the pixels.

Second step 403 may be a step of disposing an insulation layer. According to an embodiment, the insulation layer may be disposed on the bending area of the display.

According to an embodiment, the insulation layer may be disposed to cover the interconnection wires. For example, the insulation layer may make direct contact with the interconnection wires. The insulation layer may be formed to protect the interconnection wires vulnerable to cracking.

According to an embodiment, the insulation layer and/or the interconnection wires may include a groove and/or an opening that extends along the bending area.

According to an embodiment, the insulation layer may be disposed to cover the width of the bending area. Before a cutting process, the insulation layer may be disposed to cover the width of the bending area after the cutting process. The insulation layer may be disposed to cover the entire width of the bending area, or may be disposed to cover a portion of the width of the bending area, before the display is cut.

According to an embodiment, a BPL may be included in, or stacked on, the insulation layer. The BPL according to an embodiment may be disposed on the bending area and may be disposed to cover the width of the bending area.

The insulation layer and/or the BPL according to an embodiment may be implemented with a film made of a polymer or plastic. Alternatively, the insulation layer and/or the BPL may be an ultra violet (UV) curable adhesive (or film) (e.g., Loctite 3318LV).

Third step 405 may be a cutting step. According to an embodiment, third step 405 may be a step of cutting the non-active area such that the width of the insulation layer and/or the BPL after the cutting covers the width of the non-active area or the bending area. For example, at least a portion of the non-active area or the bending area may be cut together with the insulation layer and/or the BPL. After the cutting, the width of the insulation layer and/or the BPL may cover the width of the bending area.

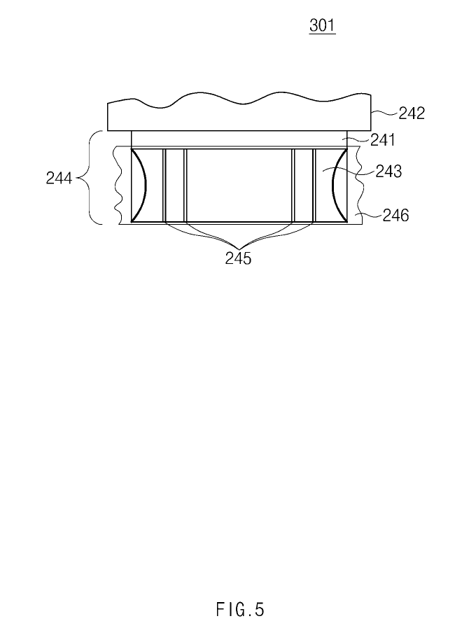

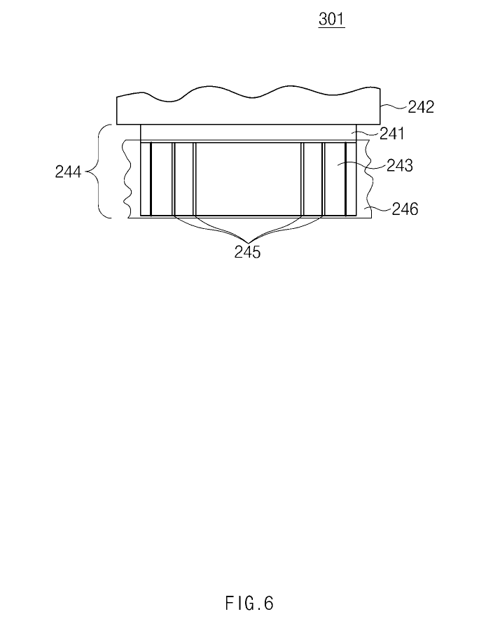

FIG. 5 illustrates a cutting pattern of a non-active area or a bending area according to an embodiment, and FIG. 6 illustrates a cutting pattern of a non-active area or a bending area according to another embodiment.

Referring to FIGS. 5 and 6, the BPL 246 may be applied to a non-active area (e.g., the non-active area 243 of FIG. 3) or a bending area (e.g., the bending area 244 of FIG. 3) (hereinafter, referred to as the bending area). According to an embodiment, interconnection wires (e.g., the interconnection wires 245 of FIG. 3) may be arranged in the bending area 244, and the BPL 246 may be applied to the bending area 244 to cover the interconnection wires 245.

Referring to FIG. 5, the bending area 244 may be cut in a semicircular shape. The BPL 246, together with the bending area 244, may be cut in a semicircular shape.

Referring to FIG. 6, the bending area 244 may be cut in a straight line. The BPL 246, together with the bending area 244, may be cut in a straight line and may cover the width of the bending area 244 after the cutting.

According to an embodiment, the BPL 246 and a flexible substrate (e.g., a PI substrate) may be cut together when the non-active area in FIGS. 5 and 6 is cut. According to an embodiment, at least one insulation layer may be disposed between the BPL 246 and the substrate in FIGS. 5 and 6. The insulation layer may be cut together when the non-active area is cut. The insulation layer and/or the BPL 246 may include a hole (e.g., a VIA hole). The VIA hole may be used for connection between the interconnection wires 245 and pixels.

Although FIGS. 5 and 6 illustrate that opposite sides of the bending area 244 are cut, the present disclosure is not limited thereto, and at least one cutting pattern may be formed.

Although FIGS. 5 and 6 illustrate that the non-active area 243 and the BPL 246 are cut in a semicircular shape or in a straight line, the cutting method may be diversely modified to make it easier to bend the bending area in various embodiments of the present disclosure. For example, the cutting pattern of the bending area 244 and the BPL 246 may have various shapes, such as an inclined, corrugated, rectangular, or trapezoidal shape.

Although FIGS. 5 and 6 illustrate that the BPL 246 is applied to the entire width of the bending area 244 before cutting, various modifications may be made to the method in which the BPL 246 is applied to the bending area 244 before cutting. For example, the BPL 246 may also be applied to a portion of the width of the bending area 244.

According to an embodiment, the width of the bending area 244 before the bending area 244 is cut may be the same as, or similar to, the width of the active area 242.

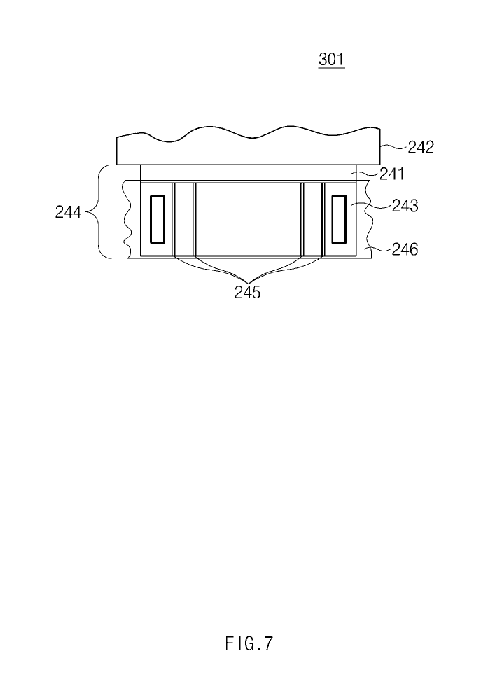

FIG. 7 illustrates a cutting pattern of a non-active area or a bending area according to another embodiment.

Referring to FIG. 7, interconnection wires (e.g., the interconnection wires 245 of FIG. 3) may be arranged in a non-active area (e.g., the non-active area 243 of FIG. 3) or a bending area (e.g., the bending area 244 of FIG. 3) (hereinafter, referred to as the bending area), and a BPL (e.g., the BPL 246 of FIG. 3) may be applied to cover the interconnection wires 245.

Referring to FIG. 7, a partial area of the display 301 (or the BPL 246) may be cut away after the BPL 246 is applied. The partial area may be an area surrounded by the BPL 246. For example, the BPL 246 may include a groove or an opening when the partial area of the BPL 246 is cut away.

According to an embodiment, a flexible substrate may be located below the BPL 246, and one or morc insulation layers may be formed between the flexible substrate and the BPL 246. When a partial area of the BPL 246 is cut away, the flexible substrate and the insulation layers below the BPL 246 may also be cut together.

Partial areas of the layers below the BPL 246 may be cut away according to a cutting pattern of the BPL 246.

According to an embodiment, at least some of the remaining layers other than the BPL 246 may be removed after the BPL 246 is applied. Even though the at least some layers are removed in a partial area below the BPL 246 after the BPL 246 is applied, the BPL 246 may still remain in the partial area. According to an embodiment, laser processing may be performed to remove the at least some layers in the partial area such that the BPL 246 remains in the partial area. The at least some layers may be removed in the state in which the BPL 246 is or is not cut.

Although FIG. 7 illustrates that the cutting pattern of the partial area has a straight-line shape, this is illustrative, and the cutting pattern may be diversely modified. For example, the cutting pattern may also be formed in an inclined direction or in the horizontal direction. Furthermore, although FIG. 7 illustrates that a pair of cutting patterns is formed on opposite sides, the position and/or number of cutting patterns may be diversely modified.

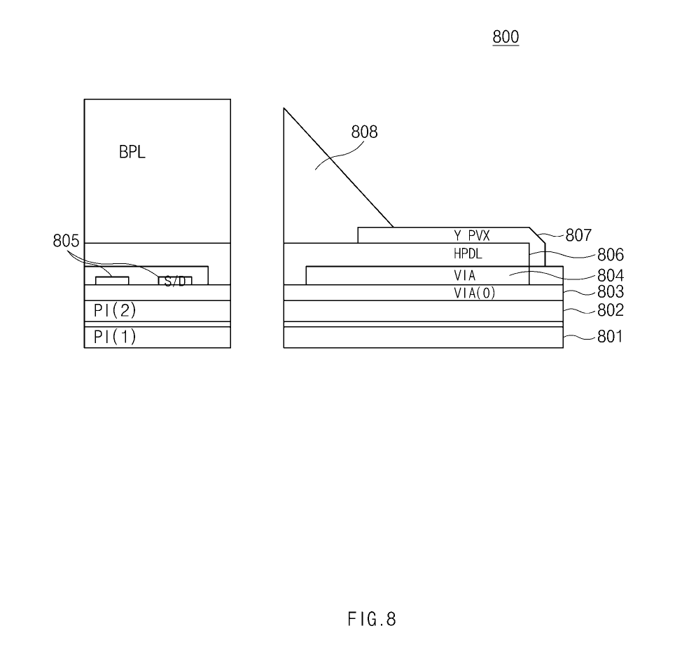

FIG. 8 illustrates a cross-section of a display corresponding to a non-active area and a BPL according to an embodiment.

FIG. 8 illustrates a cross-section of the display in the case where a partial area of the BPL 246 in FIG. 7 is cut away.

Referring to FIG. 8, a plurality of layers may be stacked between a flexible substrate and a BPL 808. The plurality of layers according to an embodiment may be insulation layers. The plurality of layers may include a VIA layer 804, a hyper pixel define layer (HPDL) 806, and a Y-passivation (Y-PVX) layer 807. The Y-PVX layer 807, the HPDL 806, and the VIA layer 804 may be arranged adjacent to the BPL 808 in sequence. The flexible substrate according to an embodiment may be a PI substrate, and the PI substrate may include a first PI layer 801 and a second PI layer 802.

According to an embodiment, the Y-PVX layer 807 may be an insulation layer or a protective layer that protects other elements. The Y-PVX layer 807 may be disposed on the HPDL 806 and may block an environment harmful to the display. The HPDL 806 may be disposed on the VIA layer 804. The HPDL 806 may be an insulation layer and may be a layer for maintaining flatness. The VIA layer 804 may be an insulation layer and may be used for inter-layer connection. The VIA layer 804 may be a photo mask that is used to etch an inter-layer dielectric film for connection with upper metal. The VIA layer 804 may include a hole (e.g., a VIA hole) for inter-layer electrical connection. The VIA layer 804 according to an embodiment may include a source/drain (S/D) metal 805.

According to an embodiment, the layers on a partial region of a bending area (e.g., the bending area 244 of FIG. 7) may be cut after the BPL 808 is applied. For example, the PI substrate may also be cut when the BPL 808 is cut. Referring to FIG. 8, the first PI layer 801, the second PI layer 802, the VIA layer 804 including a VIA(0) layer 803, the HPDL 806, the Y-PVX layer 807, and/or the BPL layer 808 may be cut according to a cutting pattern corresponding to the partial region.

According to an embodiment, only at least some of the layers may be cut when a partial area of the BPL 808 is cut. For example, the at least some layers may include the Y-PVX layer 807 and the HPDL 806.

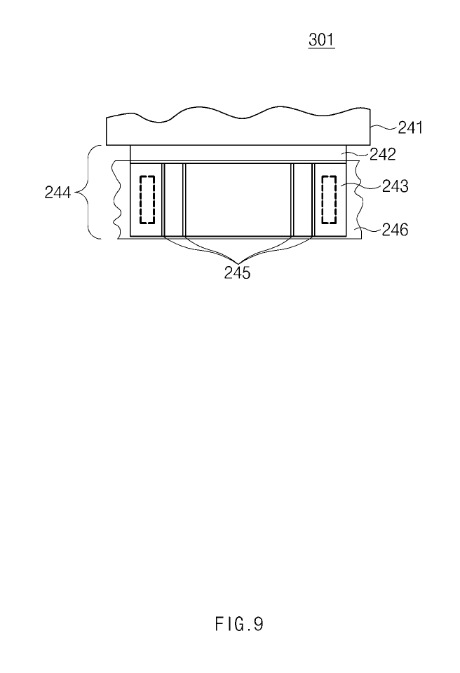

FIG. 9 illustrates a layer removal pattern in the non-active area 243 and the bending area 244 according to an embodiment.

Referring to FIG. 9, interconnection wires (e.g., the interconnection wires 245 of FIG. 3) may be arranged in a non-active area (e.g., the non-active area 243 of FIG. 3) or a bending area (e.g., the bending area 244 of FIG. 3) (hereinafter, referred to as the bending area), and a BPL (e.g., the BPL 246 of FIG. 3) may be applied to cover the interconnection wires 245.

Referring to FIG. 9, a partial area of the display 301 may be removed before the BPL 246 is applied. At least some layers in the area of the display 301 may be removed.

A plurality of layers may be arranged between a PI substrate (e.g., the first PI layer 801 of FIG. 8) and the BPL 246. According to an embodiment, before the BPL 246 is applied after a plurality of insulation layers are arranged on the PI substrate, partial areas of the PI substrate and at least some of the insulation layers may be removed.

According to an embodiment, the at least some layers removed according to a removal pattern may include at least one of a Y-PVX layer (e.g., the Y-PVX layer 807 of FIG. 8), an HPDL (e.g., the HPDL 806 of FIG. 8), and a VIA layer (e.g., the VIA layer 804 of FIG. 8).

In various embodiments of the present disclosure, the removal pattern illustrated in FIG. 9, the types of removed layers, the number of removal patterns, and/or the position of the removal pattern may be diversely modified.

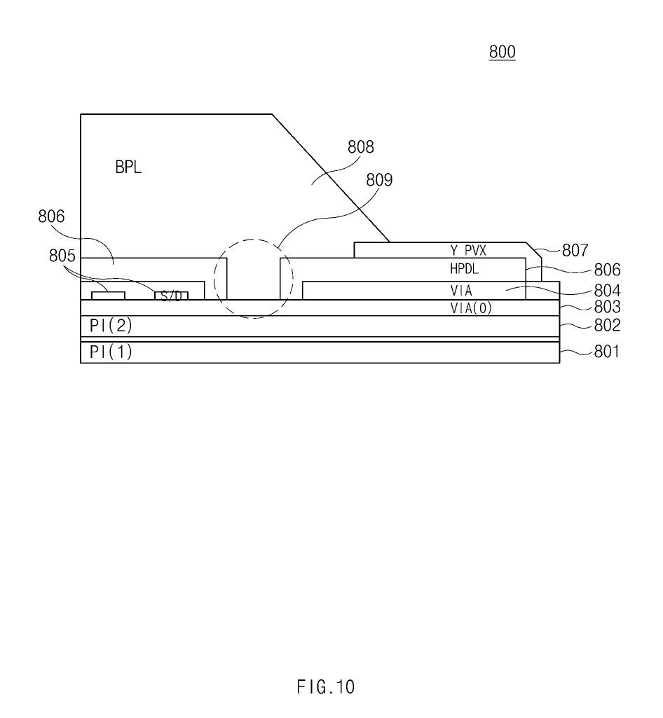

FIG. 10 illustrates a cross-section of a display corresponding to a non-active area and a BPL according to an embodiment.

Referring to FIG. 10, the display may include a valley region 809 in a non-active area (e.g., the non-active area 243 of FIG. 3) or a bending area (e.g., the bending area 244 of FIG. 3) (hereinafter, referred to as the bending area). According to an embodiment, the valley region 809 may be formed beforc the BPL 808 is applied.

According to an embodiment, the valley region 809 may be formed by stacking an additional layer between a flexible substrate and the BPL 808 (e.g., the BPL 246 of FIG. 3). The flexible substrate according to an embodiment may be a PI substrate.

Referring to FIG. 10, a display 800 (e.g., the display 120 of FIG. 1, the display 301 of FIG. 3, or the display 301 of FIGS. 5 to 7) may include a plurality of layers between the PI substrate, which includes the first PI layer 801 and/or the second PI layer 802, and the BPL 808. The plurality of layers may be, for example, insulation layers. According to an embodiment, the plurality of layers may include the VIA layer 804, the HPDL 806, and/or the Y-PVX layer 807. The source/drain (S/D) metal 805 may be disposed on the VIA layer 804 according to an embodiment. The source/drain (S/D) metal 805 may be disposed after the VIA(0) layer 803 of the VIA layer is stacked.

According to an embodiment, the BPL 808 may have the valley region 809 formed therein, which does not include at least a part of the plurality of layers between the PI substrate and the BPL 808. For example, only the VIA(0) layer 803 may exist between the valley region 809 and the PI substrate.

According to an embodiment, a partial area of a first layer may be masked when a second layer is stacked after the first layer. The second layer may not be located on the masked area when the second layer is completely stacked. In the same way, at least a portion of the masked area of the first layer may be masked when a third layer is stacked after the second layer. According to an embodiment, the BPL 808 may be applied to cover the first layer. In this case, at least a portion of the masked area may be covered with the BPL 808. Here, a region from a point of the third layer to another point of the third layer via the first layer may be the valley region 809. Although the above description has been made based on the first to third layers for the convenience of description, a layer structure for forming the valley region 809 may be diversely modified. For example, the third layer may be masked, and a fourth layer may be stacked on the third layer.

According to an embodiment, the first layer may be the VIA(0) layer 803. According to an embodiment, the third layer may be the HPDL 806.

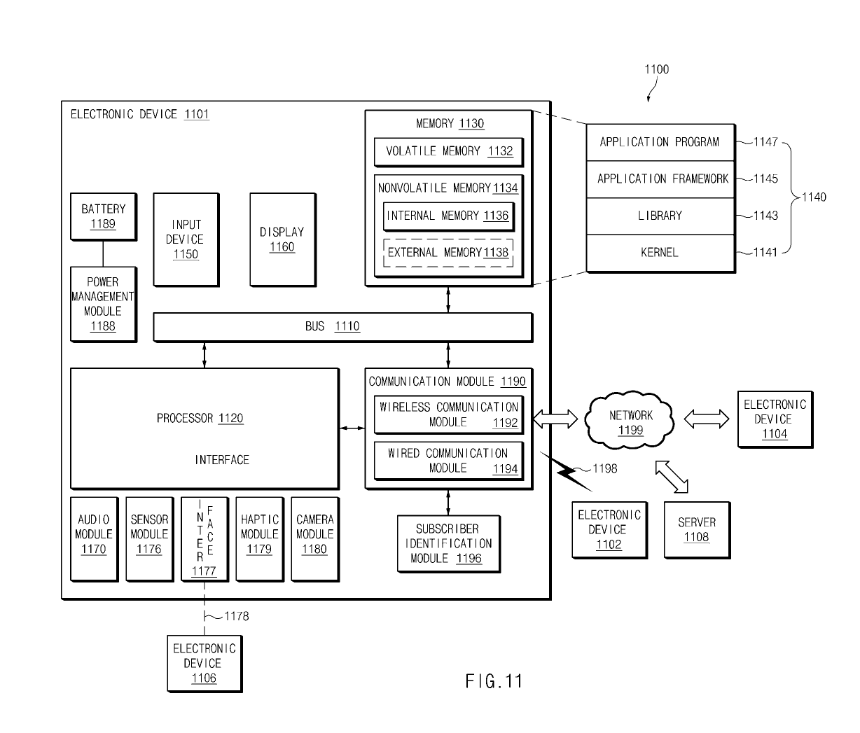

FIG. 11 illustrates a block diagram of an electronic device 1101 in a network environment 1100, according to various embodiments. An electronic device according to various embodiments of this disclosure may include various forms of devices. For example, the electronic device may include at least one of, for example, portable communication devices (e.g., smartphones), computer devices (e.g., personal digital assistants (PDAs), tablet personal computers (PCs), laptop PCs, desktop PCs, workstations, or servers), portable multimedia devices (e.g., electronic book readers or Motion Picture Experts Group (MPEG-1 or MPEG-2) Audio Layer 3 (MP3) players), portable medical devices (e.g., heartbeat measuring devices, blood glucose monitoring devices, blood pressure measuring devices, and body temperature measuring devices), cameras, or wearable devices. The wearable device may include at least one of an accessory type (e.g., watches, rings, bracelets, anklets, necklaces, glasses, contact lens, or head-mounted-devices (HMDs)), a fabric or garment-intcgrated type (e.g., an electronic apparel), a body-attached type (e.g., a skin pad or tattoos), or a bio-implantable type (e.g., an implantable circuit). According to various embodiments, the electronic device may include at least one of, for example, televisions (TVs), digital versatile disk (DVD) players, audios, audio accessory devices (e.g., speakers, headphones, or headsets), refrigerators, air conditioners, cleaners, ovens, microwave ovens, washing machines, air cleaners, set-top boxes, home automation control panels, security control panels, game consoles, electronic dictionaries, electronic keys, camcorders, or electronic picture frames.

In another embodiment, the electronic device may include at least one of navigation devices, satellite navigation system (e.g., Global Navigation Satellite System (GNSS)), event data recorders (EDRs) (e.g., black box for a car, a ship, or a plane), vehicle infotainment devices (e.g., head-up display for vehicle), industrial or home robots, drones, automatic teller's machines (ATMs), points of sales (POSs), measuring instruments (e.g., water meters, electricity meters, or gas meters), or internet of things (e.g., light bulbs, sprinkler devices, fire alarms, thermostats, or street lamps). The electronic device according to an embodiment of this disclosure may not be limited to the above-described devices, and may provide functions of a plurality of devices like smartphones which has measurement function of personal biometric information (e.g., heart rate or blood glucose). In this disclosure, the term “user” may refer to a person who uses an electronic device or may refer to a device (e.g., an artificial intelligence electronic device) that uses the electronic device.

Referring to FIG. 11, under the network environment 1100, the electronic device 1101 (e.g., the electronic device 1101) may communicate with an electronic device 1102 through local wireless communication 1198 or may communication with an electronic device 1104 or a server 1108 through a network 1199. According to an embodiment, the electronic device 1101 may communicate with the electronic device 1104 through the server 1108.

According to an embodiment, the electronic device 1101 may include a bus 1110, a processor 1120, a memory 1130, an input device 1150 (e.g., a micro-phone or a mouse), a display device 1160, an audio module 1170, a sensor module 1176, an interface 1177, a haptic module 1179, a camera module 1180, a power management module 1188, a battery 1189, a communication module 1190, and a subscriber identification module 1196. According to an embodiment, the electronic device 1101 may not include at least one (e.g., the display device 1160 or the camera module 1180) of the above-described elements or may further include other elernent(s).

The bus 1110 may interconnect the above-described elements 1120 to 1190 and may include a circuit for conveying signals (e.g., a control message or data) between the above-described elements.

The processor 1120 may include one or more of a central processing unit (CPU), an application processor (AP), a graphic processing unit (GPU), an image signal processor (ISP) of a camera or a communication processor (CP). According to an embodiment, the processor 1120 may be implemented with a system on chip (SoC) or a system in package (SiP). For example, the processor 1120 may drive an operating system (OS) or an application to control at least one of another element (e.g., hardware or software element) connected to the processor 1120 and may process and compute various data. The processor 1120 may load a command or data, which is received from at least one of other elements (e.g., the communication module 1190), into a volatile memory 1132 to process the command or data and may store the result data into a nonvolatile memory 1134.

The memory 1130 may include, for example, the volatile memory 1132 or the nonvolatile memory 1134. The volatile memory 1132 may include, for example, a random access memory (RAM) (e.g., a dynamic RAM (DRAM), a static RAM (SRAM), or a synchronous DRAM (SDRAM)). The nonvolatile memory 1134 may include, for example, a programmable read-only memory (PROM),an one time PROM (OTPROM), an erasable PROM (EPROM), an electrically EPROM (EEPROM), a mask ROM, a flash ROM, a flash memory, a hard disk drive (HDD), or a solid-state drive (SSD). In addition, the nonvolatile memory 1134 may be configured in the form of an internal memory 1136 or the form of an external memory 1138 which is available through connection only if necessary, according to the connection with the electronic device 1101. The external memory 1138 may further include a flash drive such as compact flash (CF), secure digital (SD), micro secure digital (Micro-SD), mini secure digital (Mini-SD), extreme digital (xD), a multimedia card (MMC), or a memory stick. The external memory 1138 may be operatively or physically connected with the electronic device 1101 in a wired manner (e.g., a cable or a universal serial bus (USB)) or a wireless (e.g., BLUETOOTH) manner.

For example, the memory 1130 may store, for example, at least one different software element, such as a command or data associated with the program 1140, of the electronic device 1101. The program 1140 may include, for example, a kernel 1141, a library 1143, an application framework 1145 or an application program (interchangeably, “application”) 1147.

The input device 1150 may include a microphone, a mouse, or a keyboard. According to an embodiment, the keyboard may include a keyboard physically connected or a virtual keyboard displayed through the display 1160.

The display 1160 may include a display, a hologram device or a projector, and a control circuit to control a relevant device. The screen may include, for example, a liquid crystal display (LCD), a light emitting diode (LED) display, an organic LED (OLED) display, a microelectromechanical systems (MEMS) display, or an electronic paper display. According to an embodiment, the display may be flexibly, transparently, or wearably implemented. The display may include a touch circuitry, which is able to detect a user's input such as a gesture input, a proximity input, or a hovering input or a pressure sensor (interchangeably, a force sensor) which is able to measure the intensity of the pressure by the touch. The touch circuit or the pressure sensor may be implemented integrally with the display or may be implemented with at least one sensor separately from the display. The hologram device may show a stereoscopic image in a space using interference of light. The projector may project light onto a screen to display an image. The screen may be located inside or outside the electronic device 1101.

The audio module 1170 may convert, for example, from a sound into an electrical signal or from an electrical signal into the sound. According to an embodiment, the audio module 1170 may acquire sound through the input device 1150 (e.g., a microphone) or may output sound through an output device (not illustrated) (e.g., a speaker or a receiver) included in the electronic device 1101, an external electronic device (e.g., the electronic device 1102 (e.g., a wireless speaker or a wireless headphone)) or an electronic device 1106 (e.g., a wired speaker or a wired headphone) connected with the electronic device 1101.

The sensor module 1176 may measure or detect, for example, an internal operating state (e.g., power or temperature) of the electronic device 1101 or an external environment state (e.g., an altitude, a humidity, or brightness) to generate an electrical signal or a data value corresponding to the information of the measured state or the detected state. The sensor module 1176 may include, for example, at least one of a gesture sensor, a gyro sensor, a barometric pressure sensor, a magnetic sensor, an acceleration sensor, a grip sensor, a proximity sensor, a color sensor (e.g., a red, green, blue (RGB) sensor), an infrared sensor, a biometric sensor (e.g., an iris sensor, a fingerprint senor, a heartbeat rate monitoring (FIRM) sensor, an e-nose sensor, an electromyography (EMG) sensor, an electroencephalogram (EEG) sensor, an electrocardiogram (ECG) sensor), a temperature sensor, a humidity sensor, an illuminance sensor, or an UV sensor. The sensor module 1176 may further include a control circuit for controlling at least one or more sensors included therein. According to an embodiment, the sensor module 1176 may be controlled by using the processor 1120 or a processor (e.g., a sensor hub) separate from the processor 1120. In the case that the separate processor (e.g., a sensor hub) is used, while the processor 1120 is in a sleep state, the separate processor may operate without awakening the processor 1120 to control at least a portion of the operation or the state of the sensor module 1176.

According to an embodiment, the interface 1177 may include a high definition multimedia interface (HDMI), a universal serial bus (USB), an optical interface, a recommended standard 232 (RS-232), a D-subminiature (D-sub), a mobile high-definition link (MHL) interface, a SD card/MMC(multi-media card) interface, or an audio interface. A connector 1178 may physically connect the electronic device 1101 and the electronic device 1106. According to an embodiment, the connector 1178 may include, for example, an USB connector, an SD card/MMC connector, or an audio connector (e.g., a headphone connector).

The haptic module 1179 may convert an electrical signal into mechanical stimulation (e.g., vibration or motion) or into electrical stimulation. For example, the haptic module 1179 may apply tactile or kinesthetic stimulation to a user. The haptic module 1179 may include, for example, a motor, a piezoelectric element, or an electric stimulator.

The camera module 1180 may capture, for example, a still image and a moving picture. According to an embodiment, the camera module 1180 may include at least one lens (e.g., a wide-angle lens and a telephoto lens, or a front lens and a rear lens), an image sensor, an image signal processor, or a flash (e.g., a light emitting diode or a xenon lamp).

The power management module 1188, which is to manage the power of the electronic device 1101, may constitute at least a portion of a power management integrated circuit (PMIC).

The battery 1189 may include a primary cell, a secondary cell, or a fuel cell and may be recharged by an external power source to supply power at least one element of the electronic device 1101.

The communication module 1190 may establish a communication channel between the electronic device 1101 and an external device (e.g., the first external electronic device 1102, the second external electronic device 1104, or the server 1108). The communication module 1190 may support wired communication or wireless communication through the established communication channel. According to an embodiment, the communication module 1190 may include a wireless communication module 1192 or a wired communication module 1194. The communication module 1190 may communicate with the external device through a first network 1198 (e.g. a wireless local area network such as BLUETOOTH or infrared data association (IrDA)) or a second network 1199 (e.g., a wireless wide area network such as a cellular network) through a relevant module among the wireless communication module 1192 or the wired communication module 1194.

The wireless communication module 1192 may support, for example, cellular communication, local wireless communication, global navigation satellite system (GNSS) communication. The cellular communication may include, for example, long-term evolution (LTE), LTE Advance (LTE-A), code division multiple access (CMA), wideband CDMA (WCDMA), universal mobile telecommunications system (UMTS), wireless broadband (WiBro), or global system for mobile communications (GSM). The local wireless communication may include wireless fidelity (Wi-Fi), WiFi Direct, light fidelity (Li-Fi), BLUETOOTH, BLUETOOTH low energy (BLE), Zigbee, near field communication (NFC), magnetic secure transmission (MST), radio frequency (RF), or a body area network (BAN). The GNSS may include at least one of a global positioning system (GPS), a global navigation satellite system (Glonass), Beidou Navigation Satellite System (Beidou), the European global satellite-based navigation system (Galileo), or the like. In the present disclosure, “GPS” and “GNSS” may be interchangeably used.

According to an embodiment, when the wireless communication module 1192 supports cellar communication, the wireless communication module 1192 may, for example, identify or authenticate the electronic device 1101 within a communication network using the subscriber identification module (e.g., a SIM card) 1196. According to an embodiment, the wireless communication module 1192 may include a communication processor (CP) separate from the processor 1120 (e.g., an application processor (AP)). In this case, the communication processor may perform at least a portion of functions associated with at least one of elements 1110 to 1196 of the electronic device 1101 in substitute for the processor 1120 when the processor 1120 is in an inactive (sleep) state, and together with the processor 1120 when the processor 1120 is in an active state. According to an embodiment, the wireless communication module 1192 may include a plurality of communication modules, each supporting only a relevant communication scheme among cellular communication, local wireless communication, or a GNSS communication.

The wired communication module 1194 may include, for example, include a local area network (LAN) service, a power line communication, or a plain old telephone service (POTS).

For example, the first network 1198 may employ, for example, Wi-Fi direct or BLUETOOTH for transmitting or receiving commands or data through wireless direct connection between the electronic device 1101 and the first external electronic device 1102. The second network 1199 may include a telecommunication network (e.g., a computer network such as a LAN or a WAN, the Internet or a telephone network) for transmitting or receiving commands or data between the electronic device 1101 and the second electronic device 1104.

According to various embodiments, the commands or the data may be transmitted or received between the electronic device 1101 and the second external electronic device 1104 through the server 1108 connected with the second network 1199. Each of the first and second external electronic devices 1102 and 1104 may be a device of which the type is different from or the same as that of the electronic device 1101. According to various embodiments, all or a part of operations that the electronic device 1101 will perform may be executed by another or a plurality of electronic devices (e.g., the electronic devices 1102 and 1104 or the server 1108). According to an embodiment, in the case that the electronic device 1101 executes any function or service automatically or in response to a request, the electronic device 1101 may not perform the function or the service internally, but may alternatively or additionally transmit requests for at least a part of a function associated with the electronic device 1101 to any other device (e.g., the electronic device 1102 or 1104 or the server 1108). The other electronic device (e.g., the electronic device 1102 or 1104 or the server 1108) may execute the requested function or additional function and may transmit the execution result to the electronic device 1101. The electronic device 1101 may provide the requested function or service using the received result or may additionally process the received result to provide the requested function or service. To this end, for example, cloud computing, distributed computing, or client-server computing may be used.

Various embodiments of the present disclosure and terms used herein are not intended to limit the technologies described in the present disclosure to specific embodiments, and it should be understood that the embodiments and the terms include modification, equivalent, and/or alternative on the corresponding embodiments described herein. With regard to description of drawings, similar elements may be marked by similar reference numerals. The terms of a singular form may include plural forms unless otherwise specified. In the disclosure disclosed herein, the expressions “A or B”, “at least one of A and/or B”, “at least one of A and/or B”, “A, B, or C”, or “at least one of A, B, and/or C”, and the like used herein may include any and all combinations of one or more of the associated listed items. Expressions such as “first,” or “second,” and the like, may express their elements regardless of their priority or importance and may be used to distinguish one element from another element but is not limited to these components. When an (e.g., first) element is referred to as being “(operatively or communicatively) coupled with/to” or “connected to” another (e.g., second) element, it may be directly coupled with/to or connected to the other element or an intervening element (e.g., a third element) may be present.

According to the situation, the expression “adapted to or configured to” used herein may be interchangeably used as, for example, the expression “suitable for”, “having the capacity to”, “changed to”, “made to”, “capable of” or “designed to” in hardware or software. The expression “a device configured to” may mean that the device is “capable of” operating together with another device or other components. For example, a “processor configured to (or set to) perform A, B, and C” may mean a dedicated processor (e.g., an embedded processor) for performing corresponding operations or a generic-purpose processor (e.g., a central processing unit (CPU) or an application processor) which performs corresponding operations by executing one or more software programs which are stored in a memory device (e.g., the memory 1130).

The term “module” used herein may include a unit, which is implemented with hardware, software, or firmware, and may be interchangeably used with the terms “logic”, “logical block”, “component”, “circuit”, or the like. The “module” may be a minimum unit of an integrated component or a part thereof or may be a minimum unit for performing one or more functions or a part thereof. The “module” may be implemented mechanically or electronically and may include, for example, an application-specific IC (ASIC) chip, a field-programmable gate array (FPGA), and a programmable-logic device for performing some operations, which are known or will be developed.

According to various embodiments, at least a part of an apparatus (e.g., modules or functions thereof) or a method (e.g., operations) may be, for example, implemented by instructions stored in a computer-readable storage media (e.g., the memory 1130) in the form of a program module. The instruction, when executed by a processor (e.g., a processor 1120), may cause the processor to perform a function corresponding to the instruction. The computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), an embedded memory, and the like. The one or more instructions may contain a code made by a compiler or a code executable by an interpreter.

Each element (e.g., a module or a program module) according to various embodiments may be composed of single entity or a plurality of entities, a part of the above-described sub-elements may be omitted or may further include other sub-elements. Alternatively or additionally, after being integratcd in one entity, some elements (e.g., a module or a program module) may identically or similarly perform the function executed by each corresponding element before integration. According to various embodiments, operations executed by modules, program modules, or other elements may be executed by a successive method, a parallel method, a repeated method, or a heuristic method, or at least one part of operations may be executed in different sequences or omitted. Alternatively, other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

Although the present disclosure has been described with various embodiments, various changes and modifications may be suggested to one skilled in the art. It is intended that the present disclosure encompass such changes and modifications as fall within the scope of the appended claims.

What is claimed is:

1. A display comprising:
a display panel including one or more pixels;
a display driver integrated circuit (IC) configured to drive the one or more pixels; and
a flexible substrate extending outside the display panel from at least some layers of the display panel,
wherein the flexible substrate includes:
a driver IC area on which the display driver IC is disposed; and
a bending area bent in a specified direction with respect to the display panel, with one or more interconnection wires formed in the bending area and connected to the display driver IC and the display panel and an insulation member formed on the one or more interconnection wires,
wherein the bending area is narrower than the display panel connected with the bending area, and
wherein the insulation member has a same width as the bending area.

2. The display of claim 1, wherein the flexible substrate includes the at least some layers.

3. The display of claim 1, wherein the insulation member includes a protective member configured to protect the interconnection wires.

4. The display of claim 1, wherein the insulation member includes an ultra violet (UV) curable adhesive.

5. The display of claim 1, wherein the display panel includes an insulation member disposed in an active area corresponding to the one or more pixels.

6. The display of claim 5, wherein the insulation member disposed in the active area contains a different material from the insulation member formed on the interconnection wires.

7. The display of claim 1, further comprising:
an optical clear adhesive (OCA) layer disposed on the display panel.

8. The display of claim 1, further comprising:
a polarizer disposed on the display panel.

9. The display of claim 1, wherein the flexible substrate includes a chip on plastic (COP).

10. The display of claim 1, wherein the flexible substrate includes a polyimide (PI) substrate.

11. The display of claim 1, further comprising:
a source/drain metal between the bending area of the flexible substrate and the insulation member.

12. The display of claim 1, wherein the insulation member is disposed to make direct contact with the one or more interconnection wires.

13. An electronic device comprising:
a housing including a first surface facing a first direction and a second surface facing a second direction that is different from the first direction;
a transparent member forming at least a portion of the first surface of the housing;
a display panel at least partly exposed through the transparent member and including one or more pixels; and
a flexible substrate extending outside the display panel from at least some layers of the display panel,
wherein the flexible substrate includes:
an active area corresponding to the one or more pixels; and
a bending area bent in a specified direction with respect to the display panel, with one or more interconnection wires formed in the bending area and connected to the display panel and an insulation member formed on the one or more interconnection wires,
wherein the bending area is narrower than the display panel connected with the bending area, and
wherein the insulation member has a same width as the bending area.

14. The electronic device of claim 13, wherein the flexible substrate includes the at least some layers.

15. The electronic device of claim 13, further comprising:
a display driver integrated circuit (IC) configured to drive the one or more pixels.

16. The electronic device of claim 15, wherein the display driver IC is disposed on the flexible substrate.

17. The electronic device of claim 13, wherein the housing further includes a first side and a second side that extend in parallel in a third direction when viewed from above the first surface and a third side and a fourth side that are shorter than the first side and the second side and extend in a fourth direction perpendicular to the third direction, and
wherein the width of the insulation member and the width of the bending area correspond to the third direction.

18. The electronic device of claim 13, wherein the insulation member includes an ultra violet (UV) curable adhesive.

19. The electronic device of claim 13, wherein the flexible substrate includes an insulation member disposed on the active area.

20. The electronic device of claim 19, wherein the insulation member disposed on the active area contains a different material from the insulation member formed on the interconnection wires.
